(19) United States
(12) Patent Application Publication
(10) Pub. No.: US 2011/0300422 A1
(43) Pub. Date: Dec. 8, 2011

(54) LIQUID SODIUM BATTERY

(76) Inventors: Tadahiro Ohmi, Miyagi (JP); Tetsuya Goto, Miyagi (JP); Masafumi Kitano, Miyagi (JP)

(21) Appl. No.: 13/202,109

(22) PCT Filed: Feb. 15, 2010
(86) PCT No.: PCT/JP2010/052150

§ 371 Date: Aug. 18, 2011

(30) Foreign Application Priority Data
Feb. 23, 2009 (JP) 2009-039700

(51) Int. Cl. H01M 10/39

(52) U.S. Cl. 429/81; 429/103

(57) ABSTRACT

A liquid sodium battery in which two electrode members sandwiching a partition wall formed of a Na-ion conducting solid substance are constructed by a metal having a work function whose absolute value is smaller than that of a work function of sodium and a metal having a work function whose absolute value is greater than that of the work function of sodium.

### TECHNICAL FIELD

This invention relates to a battery using a solid electrolyte plate and liquid Na.

### BACKGROUND ART

In recent years, attention is attracted to a sodium battery represented by a sodium-sulfur battery capable of storing a high-capacity power. Further, development has been made of the sodium-sulfur battery used as a power source for supplying a stabilized output in combination with wind power generation and photovoltaic generation having large output fluctuation.

The battery of the type is, as disclosed in Patent Documents 1 and 2 and the like, a kind of a secondary battery using sodium on a negative electrode side, sulfur for a positive electrode, and a ceramic alumina material (β-alumina) for an electrolyte. The battery has excellent characteristics, such as an energy density per volume as high as about three times of that of a common lead storage battery, an excellent charge-discharge cycle characteristic, and a low self-discharge.

Herein, a principle of the sodium-sulfur battery will briefly be described.

Sodium (Na) on the negative electrode side has a work function as low as 2.8 eV and, therefore, easily donates an electron to an Al alloy to become a Na⁺ ion. The Na⁺ ion passes through β-alumina having a conductivity with respect to the Na⁺ ion. The Na⁺ ion which has passed through the β-alumina forms a compound of sodium polysulfide (NaSₓ) to gain an electron from sulfur to be neutralized. Herein, sodium (Na), sulfur (S), and sodium polysulfide (NaSₓ) have melting points of 98° C., 120° C., and 285° C., respectively. Therefore, in order to keep all these substances in a liquid state, it is indispensable for the sodium-sulfur battery to be operated at a temperature of about 300° C. or above.

Further, for the purpose of dissociating Na from sodium polysulfide to return Na to its original position, cyclic battery charge is required. In a charging process, NaSₓ is dissociated to produce a Na⁺ ion which returns to liquid Na as the original position. In a conventional sodium-sulfur battery, there is a following problem. When sodium is directly brought into contact with sulfur due to a breakage or the like, a sodium-sulfur reaction is caused to occur with reaction heat. An electronic container or the like is melted down due to the reaction heat to cause leakage of active materials, such as sodium and sulfur, to the outside of the battery.

### PRIOR ART DOCUMENT

### Patent Documents

Patent Document 1: JP-A-S60-44972
Patent Document 2: JP-A-H5-54907
Patent Document 3: WO2007/043476

### SUMMARY OF INVENTION

### Problem to be Solved by Invention

As described above, in the conventional sodium-sulfur battery, a temperature of about 300° C. or above is required to operate the battery and an energy consumption for heating is indispensable. Further, the charging process for returning NaSₓ to Na and a structural design for preventing the sodium-sulfur reaction are required. Thus, an increase in cost is caused.

It is therefore an object of the present invention to provide a battery using liquid sodium and operable at a temperature lower than 300° C.

It is another object of the present invention to provide a battery using liquid sodium and operable without using sulfur.

It is still another object of the present invention to provide a battery using liquid sodium and requiring no charging process.

### Means to Solve the Problem

A liquid Na battery according to the present invention may have structures as follows.

(Structure 1)

According to the present invention, it is possible to provide a liquid Na battery comprising a first electrode, liquid Na arranged so as to be brought into contact with the first electrode, a partition wall arranged so as to be brought into contact with the liquid Na and formed of a Na-ion conducting solid substance, and a second electrode arranged on a side opposite to the first electrode with respect to the partition wall through the liquid Na, characterized in that:

the first electrode has a portion brought into contact with the liquid Na, at least a part of the portion being formed of a first conductive member having a work function whose absolute value is smaller than 2.8 eV, and

the second electrode has a portion brought into contact with the liquid Na, at least a part of the portion being formed of a second conductive member having a work function whose absolute value is greater than 2.8 eV.

(Structure 2)

According to the present invention, it is possible to provide the liquid Na battery as mentioned in the above-mentioned Structure 1, characterized by further comprising:

a first space defined between the partition wall and the first electrode and filled with the liquid Na;

a second space defined between the partition wall and the second electrode and filled with the liquid Na;

a third space filled with a pressurized inactive gas so as to be brought into contact with the liquid Na communicating with the liquid Na filling the second space;

a liquid Na flow path arranged so as to return the liquid Na from the first space to the second space and constructed so as to prevent electrical short-circuiting between the liquid Na filling the first space and the liquid Na filling the second space; and

a first output terminal arranged so as to be electrically connected to the first electrode and a second output terminal arranged so as to be electrically connected to the second electrode.

(Structure 3)

According to the present invention, it is possible to provide a liquid Na battery including a container for containing liquid Na, characterized in that:

a first portion of an inner wall of the container is formed of a first conductive member having a work function whose absolute value is smaller than 2.8 eV; and

a second portion of the inner wall of the container is formed of a second conductive member having a work function whose absolute value is greater than 2.8 eV;

the liquid sodium battery further comprising:

a partition wall formed of a Na-ion conducting solid substance and located between the first portion and the second portion in a space inside the container;

a first space defined between the partition wall and the first portion and filled with the liquid Na;

a second space defined between the partition wall and the second portion and filled with the liquid Na;

a third space filled with a pressurized inactive gas so as to be brought into contact with the liquid Na communicating with the liquid Na filling the second space;

a liquid Na flow path arranged so as to return the liquid Na from the first space to the second space and constructed to prevent electrical short-circuiting between the liquid Na filling the first space and the liquid Na filling the second space; and

a first output terminal arranged so as to be electrically connected to the first member and a second output terminal arranged so as to be electrically connected to the second member.

(Structure 4)

According to the present invention, it is possible to provide the liquid Na battery as mentioned in the above-mentioned Structure 2 or 3, characterized in that the liquid Na flowing path has a structure allowing the liquid Na to be discharged in droplets into the third space.

(Structure 5)

According to the present invention, it is possible to provide the liquid Na battery as mentioned in any one of the above-mentioned Structures 2-4, characterized in that the liquid Na filling the second space donates an electron to the second member to become a positive Na ion, the Na ion thus formed passing through the partition wall and receiving an electron from the first member to become electrically neutral, and that the liquid Na in the first space is increased by the flow of the liquid Na and an increased amount of the liquid Na returns to the second space through the liquid Na flow path,

thereby the first output terminal becoming a positive electrode, the second output terminal becoming a negative electrode.

(Structure 6)

According to the present invention, it is possible to provide the liquid Na battery as mentioned in any one of the above-mentioned Structures 1-5, characterized in that the first member is a material selected from LaB₆, NbC, ZrN, and Cs.

(Structure 7)

According to the present invention, it is possible to provide the liquid Na battery as mentioned in any one of the above-mentioned Structures 1-6, characterized in that the second member is a metal selected from Au, Ni, Pt, and Pd.

(Structure 8)

According to the present invention, it is possible to provide the liquid Na battery as mentioned in any one of the above-mentioned Structures 2-7, characterized in that, among the liquid Na's, at least the liquid Na filling the first space is added with NaF.

(Structure 9)

According to the present invention, it is possible to provide the liquid Na battery as mentioned in any one of the above-mentioned Structures 1-8, characterized in that the first member is deposited using rotary magnet sputtering.

### EFFECT OF INVENTION

According to the present invention, it is possible to obtain a liquid Na battery operable at a temperature lower than 300° C. Further, according to the present invention, it is possible to obtain a battery using liquid sodium and operable without using sulfur.

According to the present invention, it is possible to obtain a low-cost battery using liquid sodium and requiring no charging process.

### BRIEF DESCRIPTION OF THE DRAWINGS

FIG. 1 is a schematic view for describing a liquid sodium battery according to a first embodiment of the present invention.

FIG. 2 is a view for describing, more in detail, a part of the liquid sodium battery shown in FIG. 1.

FIG. 3 is a schematic view showing a part of a liquid sodium battery according to a second embodiment of the present invention.

### MODE FOR EMBODYING THE INVENTION

Next, embodiments of the present invention will be described with reference to the drawings.

### First Embodiment

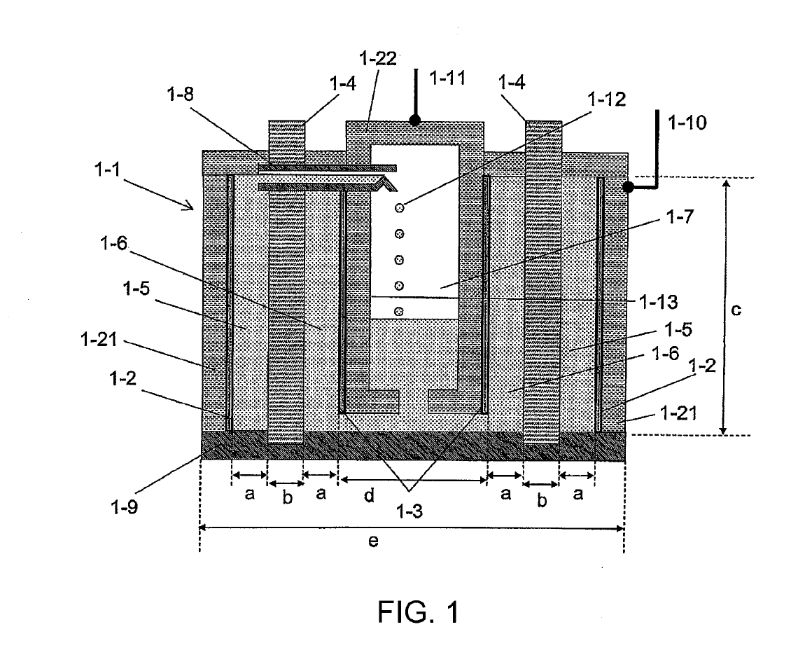

FIG. 1 shows a liquid sodium battery according to a first embodiment of the present invention, details of which will be described. A reference numeral 1-1 represents a container for containing liquid sodium (Na). 1-2 represents a LaB₆ thin film (LaB₆ electrode: first electrode) portion formed so as to coat an inner wall of the container 1-1 and having a work function whose absolute value is 2.5 eV and 1-3 represents a Pt thin film (Pt electrode: second electrode) portion having a work function whose absolute value is 5.7 eV. 1-4 represents a partition wall inserted between the LaB₆ thin film portion and the Pt thin film portion in a space inside the container. Specifically, the partition wall is formed of β-alumina which is a Na-ion conducting solid substance. The β-alumina used in the first embodiment comprises alumina with 5 to 7% of Na₂O contained therein. Herein, the LaB₆ electrode portion 1-2 forms a positive electrode and the Pt (platinum) electrode portion 1-3 forms a negative electrode.

A space (first space) inside the container 1-1, which includes the partition wall (hereinbelow called a β-alumina partition wall) 1-4 formed of the β-alumina and the LaB₆ electrode portion 1-2, is filled with liquid sodium (Na) indicated by 1-5. At the same time, a space (second space) inside the container 1-1, which includes the β-alumina partition wall 1-4 and the Pt electrode portion 1-3, is also filled with liquid sodium (Na) indicated by 1-6. Thus, it is noted here that, in the example shown in the figure, sulfur or the like other than sodium (Na) is not used.

Further, a space (third space) 1-7 filled with a pressurized Ar gas (inactive gas) so as to pressurize liquid sodium (Na) communicating with the liquid sodium (Na) 1-6 is formed inside the space filled with the liquid sodium (Na) 1-6. The Ar gas filling the space 1-7 has a pressure of 1.1 atmosphere. In order to return the sodium (Na) 1-5 on the side of the LaB₆ electrode portion 1-2 to the space 1-6 on the side of the Pt electrode portion 1-3, a liquid sodium (Na) flow path 1-8 formed by an alumina tube is arranged so as to connect upper portions of the space 1-5 and the space 1-7. The liquid sodium flow path 1-8 of the alumina tube has an outlet located in the space on the side of the Pt electrode portion 1-3 and has a structure such that the liquid sodium (Na) is discharged in droplets as indicated by 1-12.

The container 1-1 has a bottom portion 1-9 formed of alumina as an insulator and a container wall portion 1-21 which is a portion other than the bottom surface and which is formed of an electroconductive material (for example, an aluminum alloy). In the first embodiment, the LaB₆ electrode portion 1-2 is formed by sputtering deposition on the inner wall of the container wall portion 1-21 formed of the aluminum alloy. The LaB₆ electrode portion 1-2 has a film thickness of 200 nm. 1-10 represents a first output terminal which is fixed to an exterior of the container wall portion 1-21 and which is electrically connected to the LaB₆ electrode portion 1-2. The Pt electrode portion 1-3 is also formed by sputtering deposition on an outer wall surface of an aluminum-alloy tubular member 1-22 which has a tubular shape with a sealed upper portion and a bottom portion having a hole. The Pt electrode portion 1-3 has a film thickness of 200 nm.

The tubular member 1-22 encloses the pressurized space 1-7 described above with its inside bottom portion filled with the liquid sodium (Na) communicating with the liquid sodium (Na) 1-6 filling the space containing the β-alumina partition wall 1-4 and the Pt electrode portion 1-3. The tubular member 1-22 has an exterior connected to a second output terminal 1-11 which is electrically connected to the Pt electrode portion 1-3. In the first embodiment, the container of an aluminum alloy is used as a base material of the container wall portion 1-21 and the tubular member 1-22 on which the electrodes are to be deposited. However, the container material is not limited to the aluminum alloy as long as it is electrically conductive.

Each of the β-alumina partition wall 1-4, and the LaB₆ electrode portion 1-2 and the Pt electrode portion 1-3 opposite to each other has a flat plate shape. FIG. 1 shows a sectional view thereof. The β alumina partition wall 1-4 has a thickness of 1.7 mm, which is indicated by b in FIG. 1. A distance between the β alumina partition wall 1-4 and each of the LaB₆ electrode portion 1-2 and the Pt electrode portion 1-3 is 1 mm and is indicated by a in FIG. 1. Although illustrated on a reduced scale, the LaB₆ electrode portion 1-2 has a height of 1 m, which is indicated by c in FIG. 1. The electrode has a depth of 1 m in a direction perpendicular to the drawing sheet. Thus, the electrode having a size of 1 m square is formed. A distance, indicated by d in FIG. 1, between two points of the Pt electrode portion 1-3 sandwiching the space 1-7 filled with the Ar gas is 20 mm. Furthermore, the container has a width e of 37.4 mm. Thus, the container 1-1 including the container wall portion 1-21 and the bottom portion 1-9 forms a rectangular parallelepiped. The tubular member 1-22 also forms a tubular rectangular parallelepiped (quadrangular prism). Each of the container wall portion 1-21 and the tubular member 1-22 formed of an aluminum alloy has a heater embedded therein although not shown in the figure. Therefore, it is possible to heat the container as a whole.

Next, an operation of the battery will be described in detail. Pt forming the Pt electrode portion 1-3 has, as an energy level corresponding to a work function (hereinbelow called an energy level), a very low energy level of −5.7 eV and, therefore, can easily take an electron from Na having an energy level of −2.8 eV. That is, a metal (second member) (for example, Pt) having a work function whose absolute value is greater than that of the work function of Na can take an electron from Na.

The liquid sodium (Na) 1-6 in the space on the side of the Pt electrode portion 1-3 donates an electron to Pt to become a positive Na⁺ ion. The Na⁺ ion thus formed passes through the β-alumina partition wall 1-4 having a conductivity with respect to the Na⁺ ion only. The LaB₆ thin film has an energy level of −2.5 eV. Therefore, the LaB₆ electrode portion 1-2 can give an electron to the Na⁺ ion which has reached there. The Na⁺ ion receives the electron from the LaB₆ electrode portion 1-2 to become electrically neutral. That is, by using a metal (first member) (for example, LaB₆) having a work function whose absolute value is smaller than that of the work function of Na, it is possible to give an electron to the Na⁺ ion to neutralize the Na⁺ ion.

By a flow of liquid sodium (Na) thus generated, the liquid sodium (Na) 1-5 in the space on the side of the LaB₆ electrode portion 1-2 is increased in amount. The increased amount of liquid sodium passes through the liquid sodium (Na) flow path 1-8 and, as droplets 1-12, discontinuously falls down in the pressurized space 1-7 to return to the liquid sodium (Na) communicating with the liquid sodium (Na) 1-6 in the space on the side of the Pt electrode portion 1-3. As a result, the liquid sodium (Na) battery is operated with the first output terminal 1-10 as a positive electrode and the second output terminal 1-11 as a negative electrode. When the liquid sodium (Na) is returned to the liquid sodium (Na) 1-6 on the side of the Pt electrode portion 1-3, if it is connected with the liquid sodium (Na) 1-5 on the side of the LaB₆ electrode portion 1-2, the liquid sodiums (Na) in the both spaces are electrically short-circuited. As a consequence, an electromotive force is not generated.

In order to avoid electrical short circuiting between the space on the side of the LaB₆ electrode portion 1-2 and the pressurized space 1-7, it is essential to discontinuously return the liquid sodium (Na) in droplets as indicated by 1-12 in FIG. 1. Obviously, other structures may be employed if both the liquid sodiums (Na) 1-6 and 1-5 are not electrically short-circuited.

Liquid sodium (Na) has a melting point of 98° C. and has a density at each of 100° C. and 200° C. as follows.

100° C.: density 0.926 g/cm³, 2.424×10²² atom/cm³

200° C.: density 0.902 g/cm³, 2.362×10²² atom/cm³

In order to perform a battery operation, it is required to make a battery have a temperature of at least 98° C. or above so as to liquefy sodium (Na). It is noted here that, with an increase of an operation temperature, an energy consumption required for heating is increased. It is therefore desirable to use the battery in a temperature range slightly higher than the melting point. In the first embodiment, liquid sodium (Na) is heated to 110° C. and used. Meanwhile, in order to increase efficiency of the battery, it is important to enhance heat insulation property of the exterior of the container. In the first embodiment, the exterior of the container is surrounded by a vacuum insulating material having a thermal conductivity as extremely low as 0.0012 W/mK so as to minimize heat loss.

In order to achieve the above-mentioned battery operation, as an electrode on a positive electrode side, a thin film is required which has a work function whose absolute value is smaller than 2.8 eV of Na and which is chemically stable. Typically, electrons are easily removed from a low-work-function material. Therefore, the material is easily oxidized and a chemically stable thin film is difficult to be formed therefrom. In the first embodiment, by a rotary magnet sputtering technique (described in Patent Document 3 and so on) capable of performing low-damage film formation, film formation is performed with an ion irradiation amount and an ion irradiation energy controlled. As a consequence, it is possible to achieve a LaB₆ thin film which exhibits a strong orientation in a (100) direction as a crystallinity, which is chemically stable and resistant to liquid Na, and which has a work function of 2.5 eV. It is noted here that a material for the electrode on the positive electrode side (first member or first portion) is not limited to LaB₆, if the material has a work function smaller than that of sodium (Na) and a resistance to the liquid sodium (Na). For reference, examples of a low-work-function material for use as the electrode on the positive electrode side and work function values thereof are shown below.

| | |
|---|---|
| LaB₆ | 2.5 to 2.76 eV |
| NbC | 2.24 to 4.1 eV |
| ZrC | 2.18 to 4.22 eV |
| Cs | 1.95 eV |

The work functions have a range in value because they are dependent on a crystalline structure and a manufacturing method. When the LaB₆ thin film is formed by rotary magnet sputtering, a flat-plate electrode is suitable as compared to a cylindrical electrode or the like. This is because the film is formed with ion irradiation uniformly performed at all positions thereof.

If a material for an electrode on a negative electrode side (second member or second portion) has a work function whose absolute value is greater than 2.8 eV of the liquid sodium (Na) and a difference therebetween is greater, electrons are easily received to enhance ionization of the liquid sodium (Na) so that a power generation efficiency is improved. In case of a high-work-function material, it is difficult to remove electrons so that the material is hardly oxidized. Therefore, a chemically stable thin film can relatively easily be formed. For reference, work function values of electrode materials on the negative electrode side are shown below.

| | |
|---|---|
| Au | 5.1 to 5.47 eV |
| Ni | 5.04 to 5.35 eV |
| Pt | 5.64 to 5.93 eV |
| Pd | 5.55 eV |

The work functions have a range in value because they are dependent on a crystalline structure and a manufacturing method.

The present inventors have found that, when the battery is operated at 110° C., a current density of about 77 mA/cm² is obtained at each of the Pt electrode portion and the LaB₆ electrode portion. The above-mentioned current density corresponds to a Na⁺ ion stream of 4.8×10¹⁷ Na⁺ ion/cm²·sec. Per 1 m² of an electrode area:

$$4.8 \times {10}^{21} {Na}^{+} ion \text{/} {m}^{2} \cdot sec = 2.88 \times {10}^{23} {Na}^{+} ion \text{/} {m}^{2} \cdot min = 1.728 \times {10}^{25} {Na}^{+} ion \text{/} {m}^{2} \cdot hour .$$

Physical property values of sodium (Na) are shown in the following table 1.

TABLE 1

| | density | number of atoms |
|---|---|---|
| | (g/cm³) | (number/cm³) |
| 25° C. | 0.9438 | 2.47 × 10²² |
| 100° C. | 0.9261 | 2.42 × 10²² |
| 150° C. | 0.9143 | 2.39 × 10²² |
| 200° C. | 0.9025 | 2.36 × 10²² |

Considering the case at around 100° C., an amount of Na flowing through the β-alumina partition wall 1-4 of 1 m² is as follows:

| | |
|---|---|
| per minute | 11.9 cm³/m² · min |
| per hour | 714 cm³/m² · hour |

Thus, it is sufficient to continuously flow this level of liquid sodium (Na) from the side of the LaB₆ electrode portion to the side of the Pt electrode portion (when the area of each of the opposite electrodes is about 1 m²).

In FIG. 1, at the top of the LaB₆ electrode portion 1-2 and the Pt electrode portion 1-3 opposite to each other, the liquid sodium (Na) flow path 1-8 is arranged so as to connect the liquid sodium (Na) 1-5 on the side of the LaB₆ electrode and the space 1-7 whose upper portion of about two thirds contains no liquid sodium (Na) due to the pressurized Ar gas at the center. The liquid sodium (Na) falls down in droplets 1-12. Therefore, the liquid sodium (Na) 1-5 on the side of the LaB₆ electrode portion 1-2 and the liquid sodium (Na) 1-6 on the side of the Pt electrode portion 1-3 never electrically be short-circuited. Desirably, such a return path is formed at two or more positions.

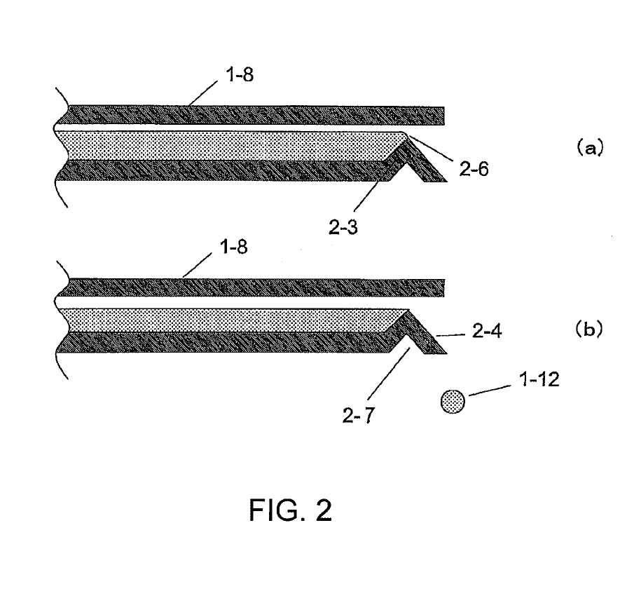

Using FIG. 2, the liquid sodium (Na) flow path will be described in detail. In the present invention, when the liquid sodium (Na) is returned to the side of the Pt electrode portion, it is essential to return the liquid sodium in droplets in order to avoid conduction with that on the side of the LaB₆ electrode portion. FIG. 2 (a) shows a state immediately before the liquid sodium (Na) becomes droplets in the liquid sodium (Na) flow path 1-8. At the outlet of the flow path of the liquid sodium (Na), a bank (dam) for blocking the liquid sodium (Na) is formed as indicated by 2-3, so that the liquid sodium (Na) does not continuously flow. The Na⁺ ion generated on the side of the Pt electrode portion moves towards the side of the LaB₆ electrode portion through the β-alumina partition wall 1-4 so as to become electrically neutral. When the liquid sodium (Na) on the side of the LaB₆ electrode portion is increased to some extent, liquid sodium (Na) in the liquid sodium (Na) flow path has a liquid level higher than the top of the bank 2-3 by an action of a surface tension, as indicated by 2-6 in FIG. 2 (a). FIG. 2 (b) shows a state in which liquid sodium (Na) is further supplied after the above-described state. As indicated by 2-4, the liquid Na flow path has a structure formed closer to an outlet side than the bank 2-3 to allow liquid sodium (Na) to slip down in droplets. Thus, a part of the increased liquid sodium (Na) becomes droplets 1-12 to return to the side of the Pt electrode portion. Referring also to FIG. 1, in this event, if the liquid sodium (Na) flows along a downside of the liquid sodium (Na) flow path 1-8 and is connected to a wall of the space 1-7 filled with the Ar gas, specifically, an inner wall 1-13 of the tubular member 1-22, conduction (short-circuiting) may possibly be caused to occur. Consequently, a stable battery operation becomes impossible. Therefore, as indicated by 2-7, it is desirable to provide the liquid sodium (Na) flow path 1-8 with a recess formed on the downside of an outer wall thereof in the vicinity of the outlet so as to prevent the liquid sodium (Na) from flowing along the outer wall of the flow path.

By the above-described iterative operation, it becomes possible to return the liquid sodium (Na) from the side of the LaB₆ electrode portion to the side of the Pt electrode portion without causing electrical conduction. Herein, one example of the structure of the liquid sodium (Na) flow path is shown. In this regard, it is important to have a structure in which electrical short-circuiting is not caused (preferably, a structure allowing discharge in droplets). As long as the above-mentioned structure is achieved, the flow path is not limited to the structure being illustrated.

### Second Embodiment

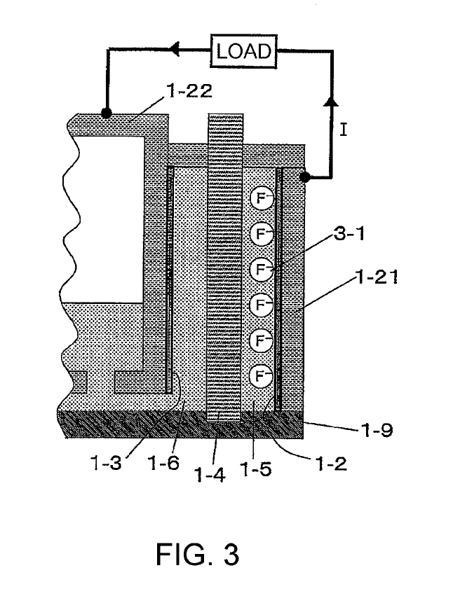

A second embodiment of the present invention will be described using FIG. 3. Description of portions overlapping with those in the first embodiment will be omitted. Further, portions equivalent to those in FIG. 1 are designated by same reference numerals. FIG. 3 shows a part of a liquid sodium (Na) battery according to the second embodiment of the present invention. A remaining part is same as that in FIG. 1 (first embodiment) except for addition of NaF. The second embodiment is characterized in that 1% NaF is added to liquid sodium (Na), particularly to the liquid sodium (Na) 1-5 on the side of the positive electrode (LaB₆ electrode portion) 1-2. NaF is dissociated into Na⁺ and F⁻ at about 100° C.

The LaB₆ electrode portion 1-2 gives an electron to a Na⁺ ion and the Pt electrode portion 1-3 takes an electron from a Na atom to convert the Na atom into a Na⁺ ion. Accordingly, an electric current I flows at the outside from the LaB₆ electrode portion 1-2 to the Pt electrode portion 1-3. When a load is connected, the LaB₆ electrode portion 1-2 has a positive voltage and the Pt electrode portion 1-3 has a negative voltage.

In this case, the positive voltage generated at the LaB₆ electrode portion 1-2 tries to inhibit the Na⁺ ion from passing to the side of the LaB₆ electrode portion 1-2. However, by adding NaF, it is possible to reduce the above-mentioned effect. Specifically, a F⁻ ion generated by dissociation of NaF approaches the LaB₆ electrode portion 1-2 to inhibit the effect of the generated positive voltage from reaching the inside the liquid sodium (Na). A F atom has an energy level of −9.42 eV. Therefore, even if the LaB₆ electrode having a work function whose absolute value is 2.5 eV (energy level being −2.5 eV) has a positive voltage of 2.0V to 2.5V, it is not possible to take an electron from the F⁻ ion and the F⁻ ion approaches the LaB₆ electrode to continuously inhibit the effect of the positive voltage. The F⁻ ions indicated by 3-1 are constantly present on the entire surface of the LaB₆ electrode portion 1-2 and cancel the effect that the positive voltage generated at the LaB₆ electrode portion 1-2 repels the Na⁺ ion. Even when the electric power is extracted to the outside and the positive voltage is generated at the LaB₆ electrode portion 1-2, the Na⁺ ion efficiently passes through the β-alumina partition wall 1-4. Thus, NaF functions as a power generation efficiency improver.

The liquid sodium batteries according to the embodiments of the present invention need not use sulfur and, therefore, can generate an electric power without heating to a high temperature.

The present invention may be achieved by the following modes (1) and (2).

(1) A liquid sodium battery characterized by comprising a partition wall formed of a Na-ion conducting solid substance, a first member which is formed of a metal having a work function whose absolute value is smaller than that of a work function of sodium and which is arranged on the side of one surface of the partition wall with a space kept therefrom, and a second member which is formed of a metal having a work function whose absolute value is greater than that of the work function of sodium and which is arranged on the side of the other surface of the partition wall with a space kept therefrom.

(2) A liquid sodium battery using liquid sodium, characterized in that electrodes are constructed by two metals selected in relation to a work function of sodium and having work functions different from each other, thereby generating an electric power with sodium only.

### INDUSTRIAL APPLICABILITY

The liquid sodium battery according to the present invention is applicable to an emergency power source during power outage, an output stabilizing power source for wind power generation or the like, an automotive power source, and the like.

### DESCRIPTION OF REFERENCE NUMERALS

1-1 container
1-2 LaB₆ thin film (LaB₆ electrode portion)
1-3 Pt thin film (Pt electrode portion)
1-4 partition wall
1-5, 1-6 liquid sodium (Na)
1-7 pressurized space
1-8 liquid sodium flow path
1-10 first output terminal
1-11 second output terminal
1-12 droplet
1-13 inner wall
1-21 container wall portion
1-22 tubular member

1. A liquid sodium battery comprising a first electrode, liquid sodium arranged so as to be brought into contact with the first electrode, a partition wall arranged so as to be brought into contact with the liquid sodium and formed of a Na-ion conducting solid substance, and a second electrode arranged on a side opposite to the first electrode with respect to the partition wall through the liquid sodium, wherein:
the first electrode has a portion brought into contact with the liquid sodium, at least a part of the portion being formed of a first conductive member having a work function whose absolute value is smaller than 2.8 eV, and
the second electrode has a portion brought into contact with the liquid sodium, at least a part of the portion being formed of a second conductive member having a work function whose absolute value is greater than 2.8 eV.

2. The liquid sodium battery as claimed in claim 1, further comprising:
a first space defined between the partition wall and the first electrode and filled with the liquid sodium;
a second space defined between the partition wall and the second electrode and filled with the liquid sodium;
a third space filled with a pressurized inactive gas so as to be brought into contact with the liquid sodium communicating with the liquid sodium filling the second space;
a liquid sodium flow path arranged so as to return the liquid sodium from the first space to the second space and constructed so as to prevent electrical short-circuiting between the liquid sodium filling the first space and the liquid sodium filling the second space; and
a first output terminal arranged so as to be electrically connected to the first electrode and a second output terminal arranged so as to be electrically connected to the second electrode.

3. A liquid sodium battery including a container for containing liquid sodium, wherein:
a first portion of an inner wall of the container is formed of a first conductive member having a work function whose absolute value is smaller than 2.8 eV; and
a second portion of the inner wall of the container is formed of a second conductive member having a work function whose absolute value is greater than 2.8 eV;
the liquid sodium battery further comprising:
a partition wall formed of a Na-ion conducting solid substance and located between the first portion and the second portion in a space inside the container;
a first space defined between the partition wall and the first portion and filled with the liquid sodium;
a second space defined between the partition wall and the second portion and filled with the liquid sodium;
a third space filled with a pressurized inactive gas so as to be brought into contact with the liquid sodium communicating with the liquid sodium filling the second space;
a liquid sodium flow path arranged so as to return the liquid sodium from the first space to the second space and constructed to prevent electrical short-circuiting between the liquid sodium filling the first space and the liquid sodium filling the second space; and
a first output terminal arranged so as to be electrically connected to the first member and a second output terminal arranged so as to be electrically connected to the second member.

4. The liquid sodium battery as claimed in claim 2, wherein the liquid sodium flowing path has a structure allowing the liquid sodium to be discharged in droplets into the third space.

5. The liquid sodium battery as claimed in claim 2, wherein the liquid sodium filling the second space donates an electron to the second member to become a positive Na ion, the Na ion thus formed passing through the partition wall and receiving an electron from the first member to become electrically neutral, and wherein the liquid sodium in the first space is increased by the flow of the liquid sodium and an increased amount of the liquid sodium returns to the second space through the liquid sodium flow path,
thereby the first output terminal becoming a positive electrode, the second output terminal becoming a negative electrode.

6. The liquid sodium battery as claimed in claim 1, wherein the first member is a material selected from LaB₆, NbC, ZrN, and Cs.

7. The liquid sodium battery as claimed in claim 1, wherein the second member is a metal selected from Au, Ni, Pt, and Pd.

8. The liquid sodium battery as claimed in claim 2, wherein, among the liquid sodiums, at least the liquid sodium filling the first space is added with NaF.

9. The liquid sodium battery as claimed in claim 1, wherein the first member is deposited using rotary magnet sputtering.

10. A liquid sodium battery comprising a partition wall formed of a Na-ion conducting solid substance, a first member which is formed of a metal having a work function whose absolute value is smaller than that of a work function of sodium and which is arranged on the side of one surface of the partition wall with a space kept therefrom, and a second member which is formed of a metal having a work function whose absolute value is greater than that of the work function of sodium and which is arranged on the side of the other surface of the partition wall with a space kept therefrom.

11. A liquid sodium battery using liquid sodium, wherein electrodes are constructed by two metals selected in relation to a work function of sodium and having work functions different from each other, thereby generating an electric power with sodium only.

12. The liquid sodium battery as claimed in claim 3, wherein the liquid sodium flow path has a structure allowing the liquid sodium to be discharged in droplets into the third space.

13. The liquid sodium battery as claimed in claim 3, wherein the liquid sodium filling the second space donates an electron to the second member to become a positive Na ion, the Na ion thus formed passing through the partition wall and receiving an electron from the first member to become electrically neutral, and wherein the liquid sodium in the first space is increased by the flow of the liquid sodium and an increased amount of the liquid sodium returns to the second space through the liquid sodium flow path,
thereby the first output terminal becoming a positive electrode, the second output terminal becoming a negative electrode.

14. The liquid sodium battery as claimed in claim 3, wherein the first member is a material selected from LaB₆, NbC, ZrN, and Cs.

15. The liquid sodium battery as claimed in claim 3, wherein the second member is a metal selected from Au, Ni, Pt, and Pd.

16. The liquid sodium battery as claimed in claim 3, wherein, among the liquid sodium, at least the liquid sodium filling the first space is added with NaF.
